(19) United States
(12) Patent Application Publication
(10) Pub. No.: US 2026/0366625 A1
(43) Pub. Date: Nov. 19, 2026

(54) BALL VALVE WITH PRESSURE RELIEF

(71) Applicant: TRANSWORLD STEEL ENTERPRISE CO., LTD., Taichung City (TW)

(72) Inventors: SHIH-YAO HUANG, Taichung City (TW); Cheng-Chun LI, Taichung City (TW)

(21) Appl. No.: 19/211,522

(22) Filed: May 19, 2025

(51) Int. Cl. F16K 5/06; F16K 17/04; F16K 27/06

(52) U.S. Cl. CPC F16K 5/0605; F16K 27/067; F16K 17/04

(57) ABSTRACT

A ball valve with pressure relief includes a main body, a ball, a bypass tube, and a pressure-releasing device. The main body has an inlet end, an outlet end, and an internal cavity therebetween. The main body has a venting hole communicated with the internal cavity. The ball in the internal cavity moves between an open position and a closed position. The ball in the open position allows a medium to flow between the inlet and outlet ends along a flow path. The ball in the closed position prevents the medium from flowing out through the outlet end. The bypass tube communicates the flow path and the venting hole. The pressure-releasing device controls communication between the venting hole and the bypass tube. Inflation of the medium remaining in the internal cavity activates the pressure-releasing device to communicate the venting hole with the bypass tube to achieve pressure relief.

### BACKGROUND OF THE INVENTION

### 1. Technical Field

This disclosure relates to ball valves, and more particularly to a ball valve with pressure relief.

### 2. Description of Related Art

It is well known that transportation of low-temperature media (such as liquefied natural gas) usually has to be conducted in a low-temperature environment to secure the media in terms of stability and safety. Ball valves that control fluid flow and pipeline connections are therefore essential for the correct operation of such transportation systems.

However, low-temperature media transported are subject to vaporization when they become warmer due to external temperature fluctuations during their transportation or storage. Such vaporization can raise pressure in related valves. Without timely and effective means to release the increased pressure, the valves can be damaged by overpressure therein, leading to shortened service lives of valves and even potential safety issues.

### SUMMARY OF THE INVENTION

To address the foregoing issue, this disclosure provides a ball valve with pressure relief, which makes a pressure-releasing device work when a medium inflates within the valve to release excessive pressure, thereby protecting the ball valve from damage and ensuring normal operation of the ball valve.

To achieve this objective, this disclosure in one embodiment provides a ball valve with pressure relief, which comprises a main body, a ball, a bypass tube, and a pressure-releasing device. The main body has an inlet end, an outlet end opposite to the inlet end, and an internal cavity that is located between the inlet end and the outlet end. The main body has a venting hole communicated with the internal cavity. The ball rotatably set in the internal cavity. The ball is provided with a through hole. The ball is configured to move between an open position and a closed position. When the ball is in the open position, the through hole communicates the inlet end with the outlet end so as to allow a medium to flow along a flow path. When the ball is in the closed position, the ball prevents the medium from flowing out through the outlet end. The bypass tube has one end communicated with the flow path and an opposite end connected to the venting hole. The pressure-releasing device is installed in the main body and is located between the venting hole and the bypass tube. The pressure-releasing device selectively controls communication between the venting hole and the bypass tube. The valve seats are installed in the internal cavity and separated from each other. Therein, when the ball is in the open position, the pressure-releasing device keeps the venting hole closed. When the ball is in the closed position, and the medium remaining in the internal cavity inflates, the pressure-releasing device operates to communicate the venting hole with the bypass tube so the excessive pressure is released to the flow path.

Thereby, with the pressure-releasing device, when the upstream tube is shut off, and the medium remaining in the internal cavity inflates, the increased internal pressure triggers the pressure-releasing device to work to communicate the venting hole with the bypass tube so that the inflated medium is discharged to the flow path through the bypass tube, thereby reducing the pressure in the internal cavity and protecting the ball valve from overpressure.

### BRIEF DESCRIPTION OF THE DRAWINGS

FIG. 1 is a perspective view of a ball valve with pressure relief according to the first embodiment of this disclosure.

FIG. 2 is a partially exploded view of the ball valve according to the first embodiment of this disclosure.

FIG. 3 is a schematic side cross-sectional view of the ball valve according to the first embodiment of this disclosure, wherein the ball is in the open position and the medium is allowed to flow from the inlet end to the outlet end.

FIG. 4 is another schematic side cross-sectional view of the ball valve according to the first embodiment of this disclosure, wherein the ball is in the closed position, and the pressure remains in the upstream tube so that a gap is formed between the valve seat near the inlet end and the ball.

FIG. 5 is another schematic side cross-sectional view of the ball valve according to the first embodiment of this disclosure, showing that inflation of the medium in the internal cavity triggers the pressure-releasing device to work to allow excessive pressure to be released to the inlet end through the bypass tube.

FIG. 6 is a schematic side cross-sectional view of a ball valve according to the second embodiment of this disclosure, wherein the ball is in the open position and the medium is allowed to flow from the inlet end to the outlet end.

FIG. 7 is another schematic side cross-sectional view of the ball valve according to the second embodiment of this disclosure, wherein the ball is in the closed position, and the pressure remains in the upstream tube so that a gap is formed between the valve seat near the inlet end and the ball.

FIG. 8 is another schematic side cross-sectional view of the ball valve according to the second embodiment of this disclosure, showing that inflation of the medium in the internal cavity triggers the pressure-releasing device to work to allow excessive pressure to be released to the inlet end through the bypass tube.

FIG. 9 is a schematic side cross-sectional view of a ball valve according to the third embodiment of this disclosure, showing that the bypass tube is a separate pipe located near the inlet end.

### DETAILED DESCRIPTION OF THE INVENTION

While preferred embodiments will be provided hereinafter for illustrating the concept of the present invention, it is to be understood that the specific description is made to better explain the principles underlying this disclosure and shall by no means be construed as limits to the scope of this disclosure.

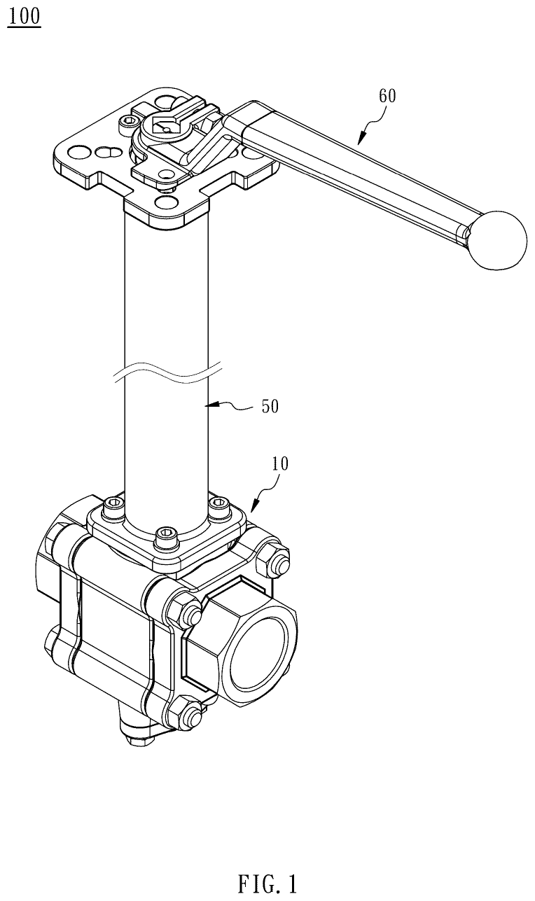

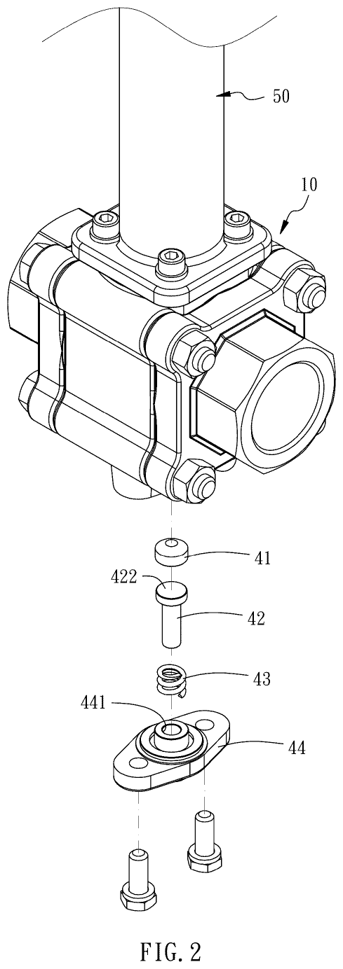

Referring to FIG. 1 through FIG. 5, a ball valve with pressure relief 100 according to the first embodiment of this disclosure comprises a main body 10, a ball 20, a bypass tube 30, a pressure-releasing device 40, a shaft 50, an operating member 60, and two valve seat 70, 71. In one embodiment, the ball valve 100 is to be installed in a pipeline for liquefied natural gas connect or disconnect tubes upstream and downstream thereto. However, the disclosed ball valve may alternatively be used in pipelines for other media, such as oil, gasoline, liquid chemicals, gaseous chemicals, etc.

The main body 10 comprises a casing 11, a first bonnet 12, and a second bonnet 13. The first bonnet 12 is attached to and seals one side of the casing 11, while the second bonnet 13 is attached to and seals an opposite side of the casing 11. The first bonnet 12 of the main body 10 is provided with an inlet end 121, and the second bonnet 13 of the main body 10 is provided with an outlet end 131 opposite to the inlet end 121. The inlet end 121 is communicated with the upstream side through a tube so that a medium M can be introduced into the ball valve 100. The outlet end 131 is communicated with the downstream side through a tube so that the medium M can be discharged. Therein, according to one embodiment, the medium M is liquefied natural gas. The inlet end 121 and the outlet end 131 are connected by and communicated with an internal cavity 14. The main body 10 has a venting hole 15 communicated with the internal cavity 14. The venting hole 15 and the internal cavity 14 are each a part of the casing 11.

The ball 20 is rotatably installed in the internal cavity 14. In an embodiment of this disclosure, the valve seats 70, 71 are spaced in the internal cavity 14. The valve seats 70, 71 abut against the ball 20 from two sides, respectively. The valve seat 70 is near the inlet end 121, and the valve seat 71 is near the outlet end 131. The ball 20 is provided with a through hole 21. The ball 20 can be switched between an open position P1 and a closed position P2. When the ball 20 is in the open position P1, the through hole 21 is communicated with the inlet end 121 and the outlet end 131 so as to allow the medium M to flow along a flow path L1. When the ball 20 is in the closed position P2, the ball 20 stops the medium M from flowing out through the outlet end 131.

In the embodiment of this disclosure, the shaft 50 is configured to rotate about rotation axis L2 that is perpendicular to the flow path L1 and is connected to the ball 20. The shaft 50 rotates in response to operation of the operating member 60 so as to drive the ball 20 to rotate about the rotation axis L2, thereby allowing or disallowing the medium M to flow. In one embodiment, the venting hole 15 is located at the side of the main body 10 that is away from the shaft 50.

The bypass tube 30 has its one end communicated with the flow path L1, and has its opposite end connected to the venting hole 15. In one embodiment, the bypass tube 30 is installed in the main body 10 with its one end communicated with the inlet end 121. The bypass tube 30 is a tubular structure installed inside the casing 11. Additionally, the casing 11 of the main body 10 has an action chamber 111 connected between the venting hole 15 and the bypass tube 30. The action chamber 111 extends in the direction parallel to the rotation axis L2. The bypass tube 30 includes a first segment 31 and a second segment 32. The first segment 31 is parallel to the rotation axis L2 and is communicated with the flow path L1. The second segment 32 is parallel to the flow path L1 and is communicated with the first segment 31 and the action chamber 111. In other embodiments, the bypass tube 30 may be a continuous tube segment, or may be a tube in a different shape, such as a curved tube or a linear tube.

The pressure-releasing device 40 is installed in the main body 10 and is located between the venting hole 15 and the bypass tube 30. The pressure-releasing device 40 is configured to selectively control communication between the venting hole 15 and the bypass tube 30 so as to selectively enable pressure relief. Therein, the pressure-releasing device 40 comprises a seal 41 installed in the action chamber 111, an actuating stem 42, a spring member 43, and an immovable base 44. The actuating stem 42 is biased by the spring member 43 to push the seal 41 toward the venting hole 15 for sealing so as to normally keep the venting hole 15 isolated from the bypass tube 30.

In some embodiments, the action chamber 111 has a first fitting portion 111a formed on its inner wall at the end near the venting hole 15, and the seal 41 has a second fitting portion 411 that matches the first fitting portion 111a so as to enhance the sealing effect of the seal 41 on the venting hole 15. In the embodiment of this disclosure, the first fitting portion 111a and the second fitting portion 411 obliquely fit with each other with their respective coniform structures. The seal 41 further has a flat portion 412 reverse to the second fitting portion 411.

The immovable base 44 is fixed to the casing 11 of the main body 10. The immovable base 44 has an action groove 441 communicated with the action chamber 111. The actuating stem 42 has a sliding portion 421 and an abutting portion 422 away from the sliding portion 421. The abutting portion 422 is plat. The sliding portion 421 of the actuating stem 42 is slidably received in the action groove 441, and the abutting portion 422 of the actuating stem 42 abuts against the flat portion 412 of the seal 41. The spring member 43 has one end abutting against the immovable base 44 and an opposite end abutting against a retaining portion 423 of the actuating stem 42, so that the seal 41 is normally pushed by the spring member 43 toward and seals the venting hole 15.

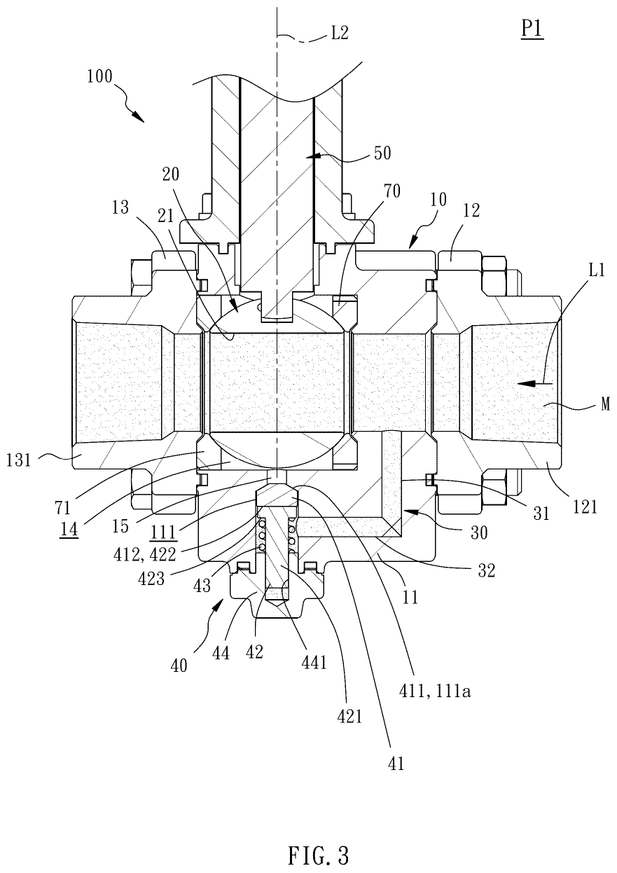

As shown in FIG. 3, when the medium M comes from the upstream tube and the ball 20 is in the open position P1, while most of the medium M flows from the inlet end 121 to and beyond the outlet end 131 through the through hole 21, a part of the medium M enters the bypass tube 30 and flows to the pressure-releasing device 40. In this way, pressure equilibrium is achieved between the ball valve 100 and the tube. At this time, the pressure-releasing device 40 stays inactive and the venting hole 15 is sealed.

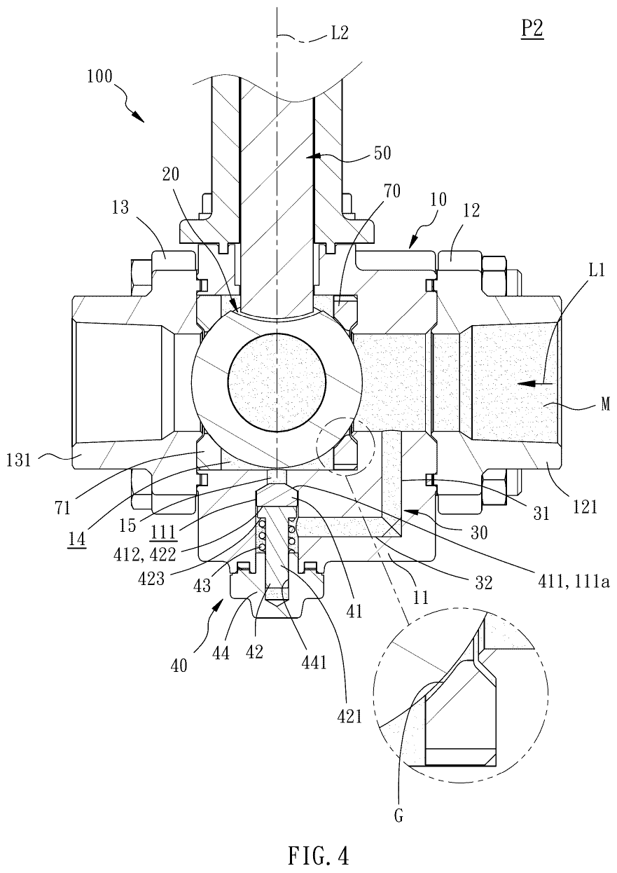

Referring to FIG. 3 and FIG. 4, when the ball 20 is moved to the closed position P2 from the open position P1, the ball 20 and the valve seat 70 combine to block the medium M from passing through the flow path L1, and some of the medium M may remain in the internal cavity 14. Furthermore, when the medium M is supplied through the upstream tube and adds the pressure acting on the ball 20, the medium M may have the ability to push the ball 20 toward the other valve seat 71, so that a gap G is formed between the ball 20 and the valve seat 70 that communicates the internal cavity 14 and the inlet end 121. In the state shown in FIG. 4, since pressure equilibrium is achieved between the ball valve 100 and the tube, and the medium M remaining in the internal cavity 14 is not subject to inflation, which means there is no any overpressure, the pressure-releasing device 40 stays inactive.

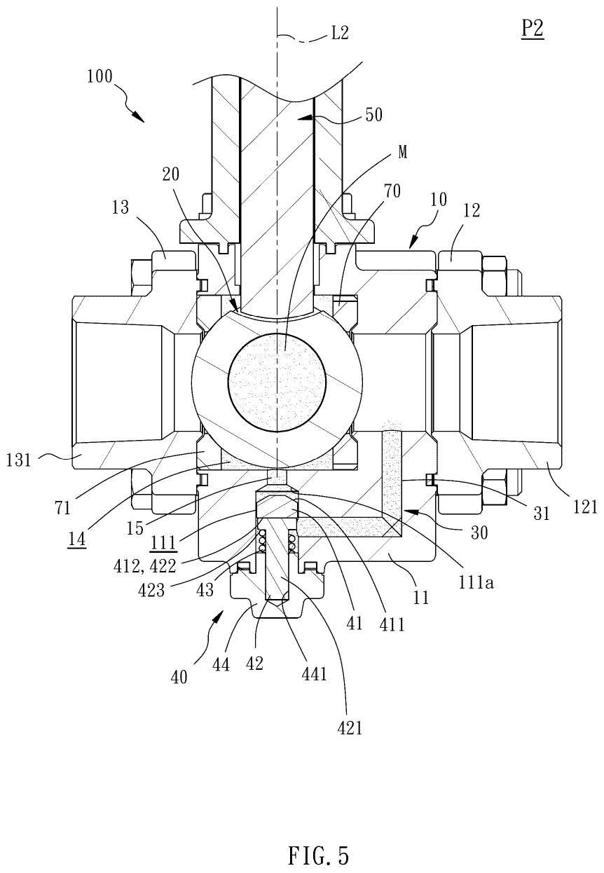

As shown in FIG. 5, when the upstream tube is shut off, and there is no more medium M flowing in through the inlet end 121, the ball 20 and the valve seats 70, 71 combine to make the internal cavity 14 an independent inner space. Thereby, when the medium M remaining in the internal cavity 14 undergoes inflation due to the temperature or other reasons and makes the pressure become greater than the springiness of the spring member 43 of the pressure-releasing device 40, the actuating stem 42 and the seal 41 are pushed downward so that the venting hole 15 is communicated with the bypass tube 30 to allow the pressure to be released to the flow path L1. This means that the inner pressure is discharged from the bypass tube 30 to the inlet end 121 and the ball valve 100 is protected from damage caused by overpressure. This disclosure thereby helps to extend the service life of the ball valve 100.

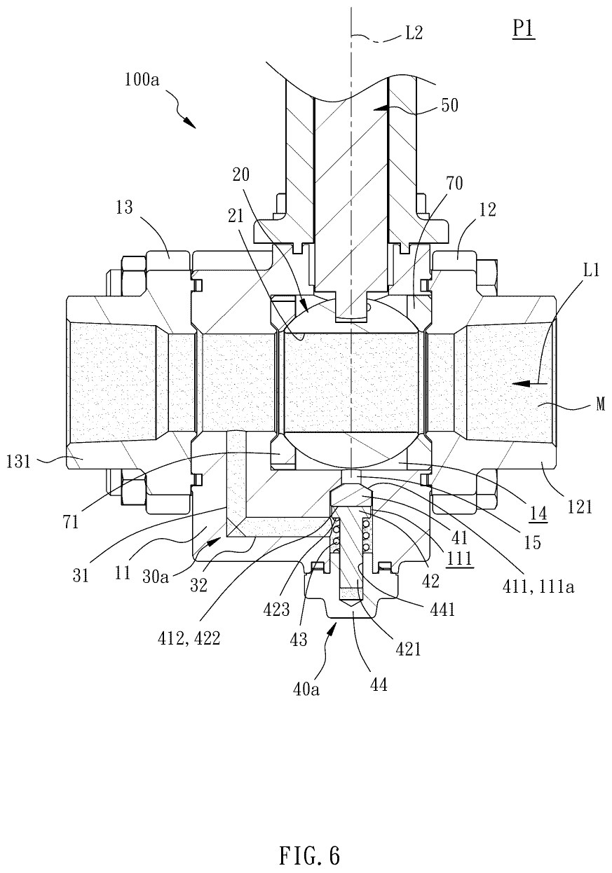

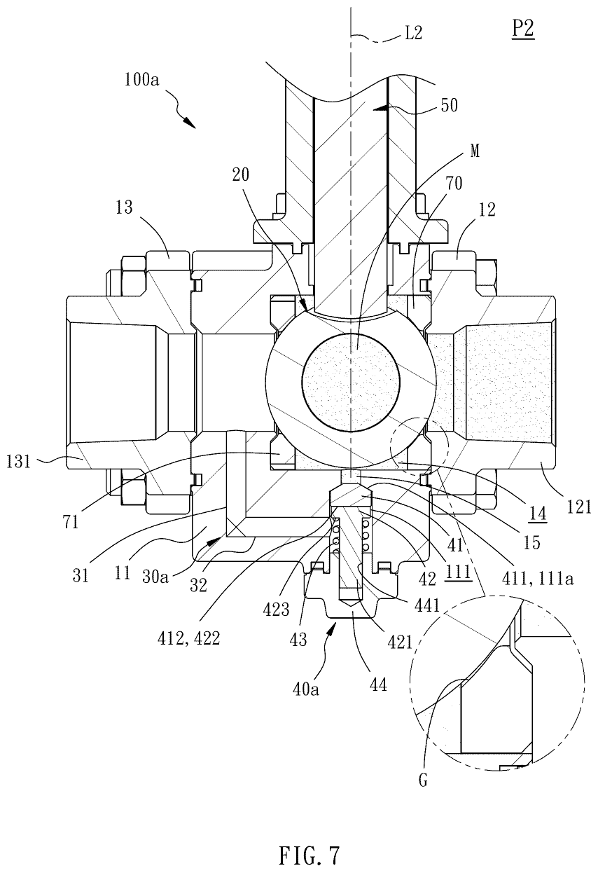

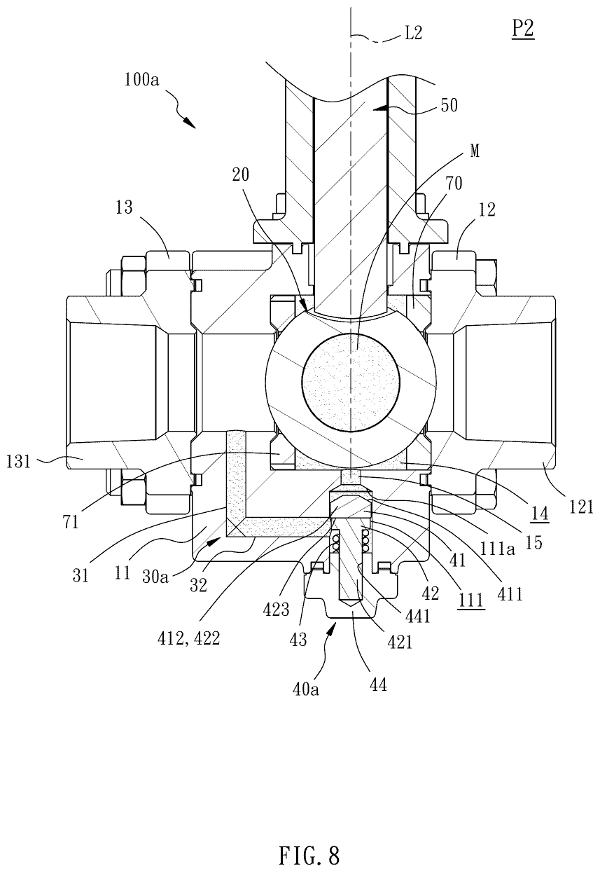

Referring to FIG. 6 through FIG. 8, in the second embodiment of this disclosure, the bypass tube 30a is provided in the main body 10. The bypass tube 30a has one end communicated with the outlet end 131. The pressure-releasing device 40a is located between the venting hole 15 and the bypass tube 30a. As described previously, when the ball 20 is in the open position P1, since pressure equilibrium is achieved, the pressure-releasing device 40a is inactive and keeps the venting hole 15 sealed. When the ball 20 is switched to the closed position P2 from the open position P1, and when the medium M remaining in the internal cavity 14 causes overpressure in the internal cavity 14 that reaches a threshold set for the pressure-releasing device 40a, the pressure-releasing device 40a performs pressure relief by allowing the pressure to be released to the outlet end 131 through the bypass tube 30a, so as to protect the ball valve 100a from excessive inner pressure.

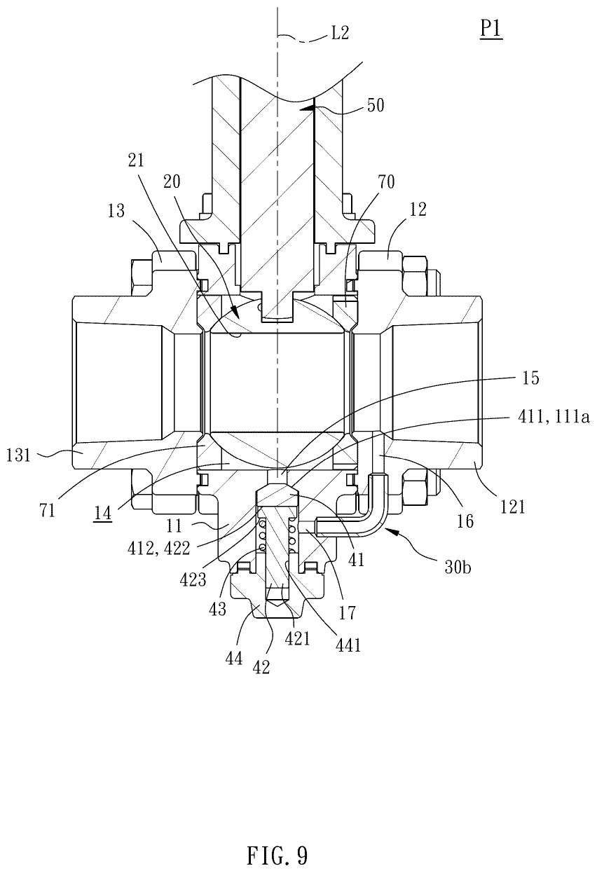

Referring to FIG. 9, in the third embodiment of this disclosure, the bypass tube 30b is a separate tube and is located near the inlet end 121. The main body 10 has a first channel 16 communicated with the flow path L1 and a second channel 17 communicated with the venting hole 15. The bypass tube 30b is exposed outside the main body 10. The bypass tube 30b has one end communicated with the first channel 16 and an opposite end communicated with the second channel 17. The bypass tube 30b is communicated with the venting hole 15 through the action groove 441, so as to similarly function for pressure relief. In other embodiments of this disclosure, the bypass tube 30b may alternatively be a separate tube that is located near the outlet end 131.

To sum up, with the pressure-releasing device 40 or 40a, when the upstream tube is shut off and the medium M remaining in the internal cavity 14 undergoes inflation, the increased inner pressure can be discharged to the flow path L1 through the bypass tube 30a, so as to protect the ball valve 100 or 100a from damage caused by overpressure.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A ball valve with pressure relief, comprising:
a main body, having an inlet end, an outlet end opposite to the inlet end, an internal cavity, a venting hole, and an action chamber, wherein the internal cavity is located between the inlet end and the outlet end, and the venting hole communicates with the internal cavity;
a ball, being rotatably set in the internal cavity, the ball having a through hole, the ball being configured to move between an open position and a closed position, when the ball is in the open position, the through hole being communicated with the inlet end and the outlet end so as to allow a medium to flow along a flow path, and when the ball is in the closed position, the ball stops the medium from flowing out through the outlet end;
a bypass tube, having one end communicated with the flow path and an opposite end connected to the venting hole via the action chamber;
a pressure-releasing device, being installed in the main body and being located between the venting hole and the bypass tube, the pressure-releasing device selectively controlling communication between the venting hole and the bypass tube, wherein the pressure-releasing device comprises a seal, an actuating stem, and a spring member installed in the action chamber, in which the actuating stem pushes the seal toward the venting hole to seal the venting hole due to springiness of the spring member, so as to keep the venting hole and the bypass tube not communicated with each other; and
a shaft that rotates about a rotation axis perpendicular to the flow path so that the shaft is connected to the ball, wherein the action chamber extends in a direction parallel to the rotation axis, and the venting hole is located at one side of the main body that is away from the shaft;
wherein, when the ball is in the open position, the pressure-releasing device keeps the venting hole sealed, and when the ball is in the closed position and the medium remaining in the internal cavity undergoes inflation, the pressure-releasing device is activated to communicate the venting hole with the bypass tube, and the medium undergoing the inflation makes the pressure greater than the springiness of the spring member, the seal and the actuating stem move to allow the venting hole and thereby releasing pressure to the flow path.

2. The ball valve with pressure relief of claim 1, wherein the bypass tube is located in the main body and has one end communicated with the inlet end, so that when the pressure-releasing device is activated, the pressure is discharged to the inlet end through the bypass tube.

3. The ball valve with pressure relief of claim 1, wherein the bypass tube is located in the main body and has one end communicated with the outlet end, so that when the pressure-releasing device is activated, the pressure is discharged to the outlet end through the bypass tube.

4. (canceled)

5. A ball valve with pressure relief, comprising:
a main body, having an inlet end, an outlet end opposite to the inlet end, an internal cavity, a venting hole, and an action chamber, wherein the internal cavity is located between the inlet end and the outlet end, the venting hole communicates with the internal cavity, and the action chamber has an inner wall provided with a first fitting portion at one end thereof near the venting hole;
a ball, being rotatably set in the internal cavity, the ball having a through hole, the ball being configured to move between an open position and a closed position, when the ball is in the open position, the through hole being communicated with the inlet end and the outlet end so as to allow a medium to flow along a flow path, and when the ball is in the closed position, the ball stops the medium from flowing out through the outlet end;
a bypass tube, having one end communicated with the flow path and an opposite end connected to the venting hole via the action chamber;
a pressure-releasing device, being installed in the main body and being located between the venting hole and the bypass tube, the pressure-releasing device selectively controlling communication between the venting hole and the bypass tube, wherein the pressure-releasing device comprises a seal, an actuating stem, and a spring member installed in the action chamber, in which the actuating stem pushes the seal toward the venting hole to seal the venting hole due to springiness of the spring member, so as to keep the venting hole and the bypass tube not communicated with each other, and the seal has a second fitting portion that matches the first fitting portion; and
wherein, when the ball is in the open position, the pressure-releasing device keeps the venting hole sealed, and when the ball is in the closed position and the medium remaining in the internal cavity undergoes inflation, the pressure-releasing device is activated to communicate the venting hole with the bypass tube, thereby releasing pressure to the flow path.

6. The ball valve with pressure relief of claim 5, wherein the pressure-releasing device further comprises an immovable base fixed to the main body, the immovable base having an action groove communicated with the action chamber, the actuating stem having one end received in the action groove, the spring member having one end abutting against the immovable base, and the spring member having an opposite end abutting against the actuating stem.

7. The ball valve with pressure relief of claim 6, wherein the actuating stem has a sliding portion and an abutting portion away from the sliding portion, in which the sliding portion is located in the action groove, and the ball valve further comprises two valve seats that are separate and are installed in the internal cavity, so that the two valve seats abut against two sides of the ball, respectively.

8. (canceled)

9. The ball valve with pressure relief of claim 1, wherein the bypass tube is located in the main body, and has a first segment and a second segment, in which the first segment is parallel to the rotation axis and is communicated with the flow path, and the second segment is parallel to the flow path and is communicated with the first segment and the action chamber.

10. A ball valve with pressure relief, comprising:
a main body, having an inlet end, an outlet end opposite to the inlet end, and an internal cavity, wherein the internal cavity is located between the inlet end and the outlet end, the venting hole communicates with the internal cavity, and the main body has a first channel communicated with a flow path and a second channel communicated with the venting hole;
a ball, being rotatably set in the internal cavity, the ball having a through hole, the ball being configured to move between an open position and a closed position, when the ball is in the open position, the through hole being communicated with the inlet end and the outlet end so as to allow a medium to flow along a flow path, and when the ball is in the closed position, the ball stops the medium from flowing out through the outlet end;
a bypass tube, having one end communicated with the flow path and an opposite end connected to the venting hole; and
a pressure-releasing device, being installed in the main body and being located between the venting hole and the bypass tube, the pressure-releasing device selectively controlling communication between the venting hole and the bypass tube, wherein the bypass tube is a separate tube, and the bypass tube is exposed outside the main body and has one end communicated with the first channel and an opposite end communicated with the second channel;
wherein, when the ball is in the open position, the pressure-releasing device keeps the venting hole sealed, and when the ball is in the closed position and the medium remaining in the internal cavity undergoes inflation, the pressure-releasing device is activated to communicate the venting hole with the bypass tube, thereby releasing pressure to the flow path.
